(19) United States
(12) Patent Application Publication
(10) Pub. No.: US 2014/0009928 A1
(43) Pub. Date: Jan. 9, 2014

(54) Decorative Laminated Patch with LED

(71) Applicant: Ning Zhang, Markham (CA)

(72) Inventor: Ning Zhang, Markham (CA)

(21) Appl. No.: 13/541,297

(22) Filed: Jul. 3, 2012

(51) Int. Cl. F21L 4/04

(52) U.S. Cl. CPC F21L 4/04
USPC 362/231; 362/234

(57) ABSTRACT

The utility patent discloses a decorative laminated patch with LED. A printed circuit board, at least one LED luminous tube and a control circuit with a switch form a luminous component. The character of a decorative laminated patch with LED is that the luminous component is arranged in a circumferentially sealed plastic bag, wherein the bottom of the plastic bag is a connecting surface, the top of the plastic bag is a decorative surface, and a transparent or semi-transparent structure is arranged at the position corresponding to the LED luminous tube on the decorative surface. By means of arranging the luminous component in the sealed plastic bag, the utility patent not only has the functions of luminescence and vocalization, but also has waterproof function and is suitable for the products which are easy to get wet and need to be washed and the hand feel of the product is soft.

### TECHNICAL FIELD

This utility patent relates to a decorative product which adopts LED, specifically related to a decorative patch, and can be used for children's blankets and crib bumpers and other bedding products which are easy to get wet and need washing.

### BACKGROUND TECHNOLOGY

With the utilization of a LED light emitting circuit or the combination of LED light-emitting circuit and sound circuit, various light-emitting toys, light-emitting and sound toys and various decorations can be made. With the increasing maturity of existing LED light-emitting and control circuit technology, the functions such as the flashing and alternating to different colors of LED lights and radiation of the lights to the changing rhythm of the sound circuit can be easily realized, and the sound circuit containing multiple musical pieces and voices are gradually becoming increasingly small and exquisite. Matching with the power supply from button battery, this kind of sound and light-emitting circuit can be reduced to the size of several centimeters, and be widely applied to the decoration and toy field.

However, problems will occur when attempting to combine the LED light-emitting circuit with the various beddings such as children's blankets, crib bumpers, pillows and cushions etc. On the one hand, the beddings need to be washed regularly, but it is difficult to wash them because of being equipped with LED light-emitting circuit. On the other hand, when blankets used by the infants, for example, such situations as defecation, regurgitating milk or even spillover of drinking water, may lead to water inflowing into the LED light-emitting circuit, resulting in short circuit or the damage of the circuit. When it is used on the other occasions where it is close to water, the same problems will also appear.

However, since infants are the group who are interested in light-emitting or sounding objects, resolution of the problems mentioned above will open up a broad market for the application of LED light-emitting circuits.

### CONTENTS OF THE INVENTION

The utility patent aims to provide a decorative laminated patch with LED which can not only provide light-emitting or light-emitting sounding features, but also is suitable for the products which are easy to get wet or need washing and it plays a role in decoration, too.

In order to reach the above aim, the technical scheme adopted for this utility model patent is: The decorative laminated patch with LED, a printed circuit board, at least one LED luminous tube and a control circuit with a switch form a luminous component, which is arranged in a circumferentially sealed plastic bag, wherein the bottom of the plastic bag is a connecting surface, the top of the plastic bag is a decorative surface, and a transparent or semi-transparent structure is arranged at the position corresponding to the LED luminous tube on the decorative surface.

The technology for the referred light-emitting component has been in existence. The different lighting effects can be easily realized by setting LED luminotrons of different quantity and colors and changing the output waveform of control circuit, which makes it with the entertainment and decoration features. The light-emitting component is arranged in a sealed plastic bag, which makes it with water-proof function, and therefore, the blanket or crib bumpers and bedding products can be washed.

In the above technical scheme, to realize the connection between decorative patch and the object it decorates, the adopted scheme is: the connection side of the referred plastic bag is fixedly connected with either loop or hook of a Velcro, and accordingly the blanket or the crib bumpers are fixedly connected with the hook or loop of a Velcro, and thus realizing the connection between the decorative sheet and the object it decorates.

Or configure the outside of the sealed periphery of the referred plastic bag with connection edge extending to the surround, and sew the decorative laminated patch to the object fixedly along the suture set on the said connection edge.

The connecting surface of the referred plastic bag can also be fixedly connected with one part of the snap button, and the object to be decorated can be set with the other part of the snap button, realizing the connection between the decorative patch and the object through the fixed connection of the snap button.

Of course, the decorative patch can also be connected to the object to be decorated by means of gluing, or arrange a transparent bag on the object, into which the decorative laminated patch with LED shall be placed.

In the above technical scheme, LED luminotron can be configured according to the actual needs. An optimized scheme for which is that we can set up 3 LED luminotrons, but not limited to 3 colors, which respectively glow in red, green and yellow colors.

In the further technical scheme, the referred printed circuit board can also be set up with sound circuit, which can adopt ready-made sounding chip, and work in combination with a micro speaker. Its on-off switch can be controlled by the same on-off button of the light-emitting component.

In the further technical scheme, the referred control circuit can also be set up with a delay-off circuit. When using it, press the button to switch on the decorative laminated patch with LED, and after the pre-set time, the decorative patch will automatically switch off. This structure is particularly suitable for decoration on children's toys, for it can avoid shortening the battery service life caused by long-time working.

Due to the application of the above technical scheme, compared with the existing technologies, this utility patent has the following advantages:
1. By arranging the light-emitting component into a laminated bag with sealed periphery, this utility model patent has water-proof function, making it suitable for the products which are easy to get wet and need to be washed.
2. The top of the plastic bag is a decorative surface, and the corresponding position of LED luminotrons on which is of transparent or semi-transparent structure, realizing different luminous effects. And meanwhile, different decoration patterns can be printed on the decorative surface, enhancing its entertainment and decoration features.
3. The bottom of the plastic bag is a connection surface, which can be connected to the object decorated through Velcro, sewing and gluing, among which the Velcro structure can also make the removing of the decoration sheet convenient. Removing the decoration patch for washing will elongate the service life of decoration sheet.
4. The utility patent is of simple structure, low cost, wide application, making it suitable for wide promotion.
5. The product is soft by hand feel which is suitable for decorating with baby plush bedding products.

### DESCRIPTION OF ATTACHED FIGURES

FIG. 1 is the structure diagram of the application case I of the utility patent;

FIG. 2 is the enlarged structure diagram of Figure II in A-A section side-looking view;

FIG. 3 is the back view diagram of FIG. 1

FIG. 4 is the diagram of the application case II of the utility patent;

FIG. 5 is the diagram of the application case III of the utility patent;

FIG. 6 is the use status schematic of the utility patent in application case III.

In which: 1. printed circuit board; 2. LED luminotrons; 3. plastic bag; 4. Velcro; 5. a control circuit with a switch for light or sound

### DETAILED METHOD OF APPLICATION

Further description of the utility patent will be given in combination with the figures and application cases.

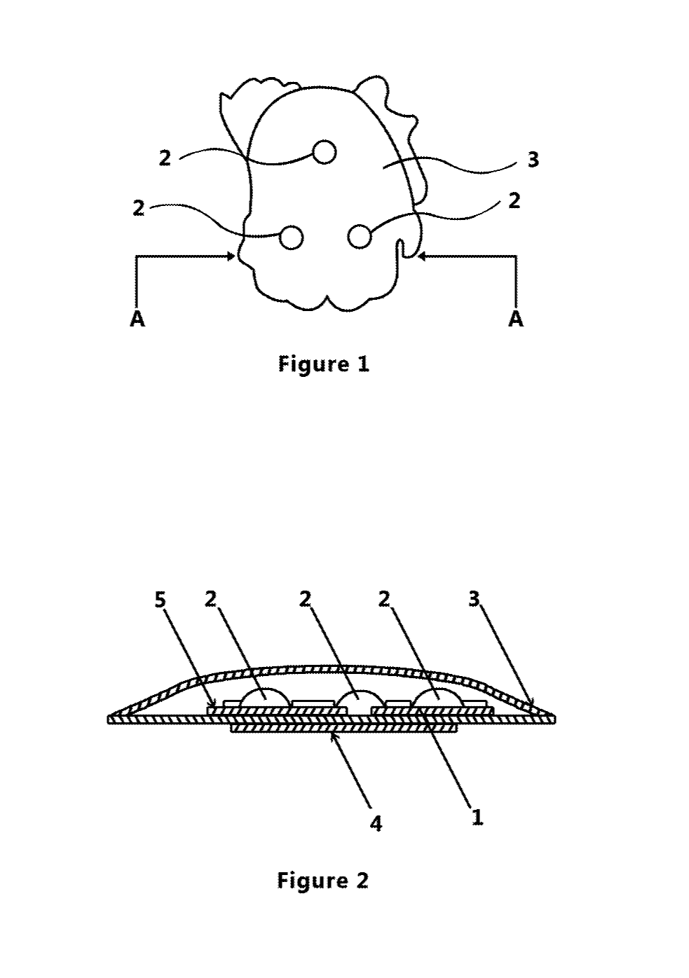

Application case I: as shown in FIG. 1 and FIG. 2, this is the decorative laminated patch with LED, composed of a printed circuit board 1, 3 LED luminotrons 2, and a control circuit with a switch 5; the light emitting or sound component is arranged in a plastic bag 3 with sealed periphery; the bottom of the referred plastic bag is a connection surface; the top is a decorative surface; and the position corresponding to the LED luminotron on the decorative surface is a transparent or semitransparent structure. The referred LED luminotrons are respectively of the color of red, green and yellow.

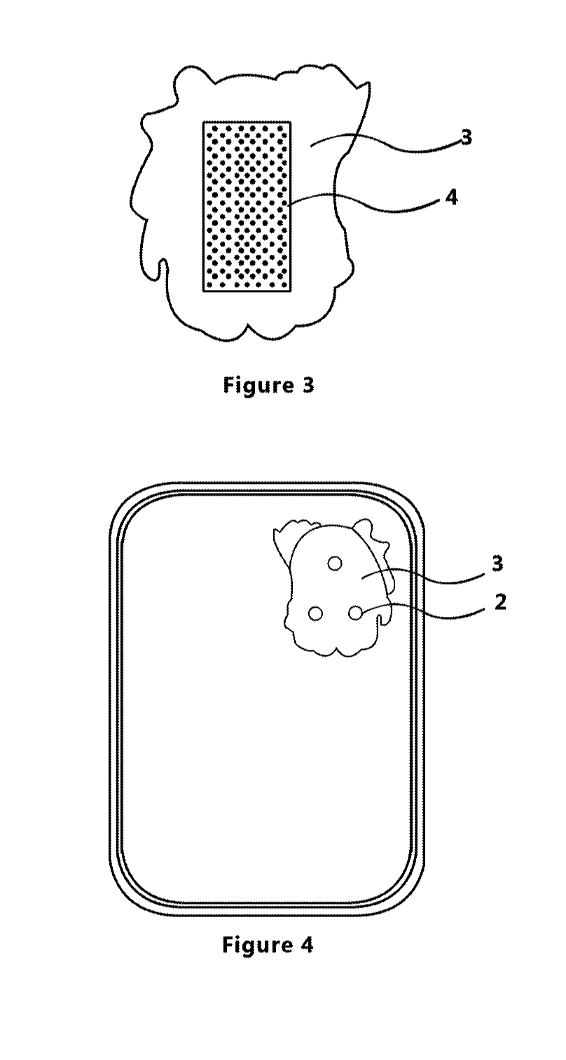

As shown in FIG. 3, the connection surface of the referred plastic bag is fixedly connected with a Velcro 4 either on the hook or the loop. And accordingly, the object decorated is fixedly connected to the loop or hoop of the Velcro, and thus the decorative patch is connected to the object through the decorative patch

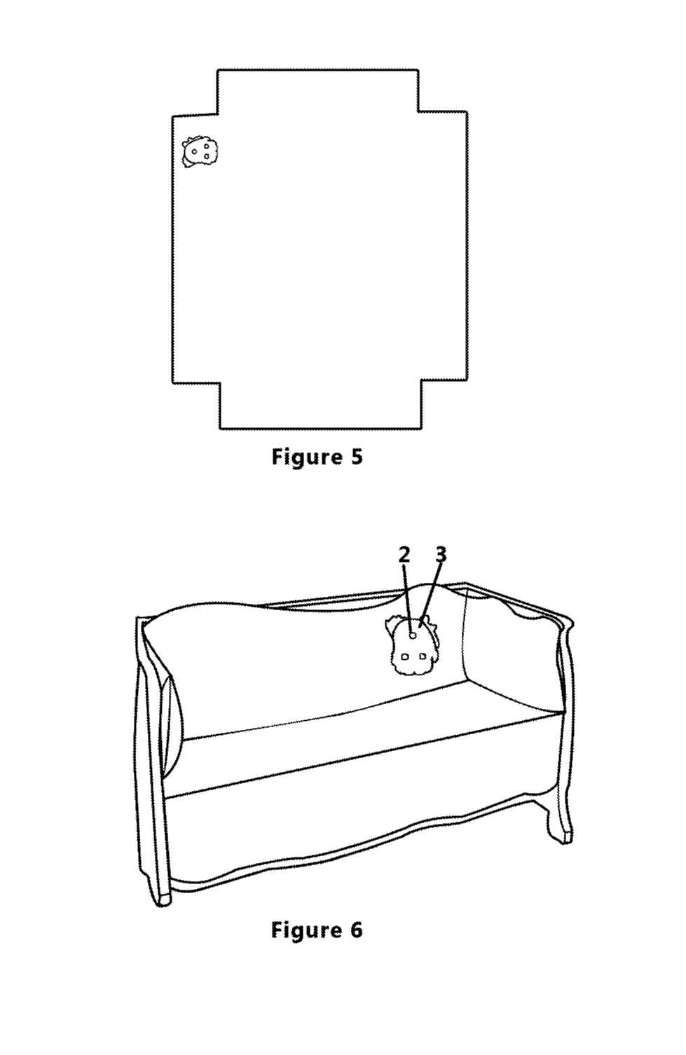

Application case II: as shown in FIG. 5, this is the decorative laminated patch with LED, composed of a printed circuit board 1, 3 LED luminotrons 2 and a control circuit with a switch; the light emitting component is arranged in a plastic bag 3 with sealed periphery; the bottom of the referred plastic bag is a connection surface; the top is a decorative surface; and the position corresponding to the LED luminotron on the decorative surface is a transparent or semitransparent structure.

As shown in FIG. 4, the sealed periphery of the referred plastic bag is set up with the connection periphery extending to the surroundings, which could be sewn to children's blanket fixedly.

Application case III: the structure of the decorative laminated patch with LED is similar to that in application case I.

As shown in FIG. 5 and FIG. 6, the connection face of the plastic bag is fixedly connected with a Velcro either on the hook or the loop, and can be pasted on the crib bumpers for use.

1. A decorative laminated patch with LED: A printed circuit board (1), at least one LED luminous tube (2) and a control circuit with a switch form a luminous component. The character of a decorative laminated patch with LED is that the luminous component is arranged in a circumferentially sealed plastic bag (3), wherein the bottom of the plastic bag is a connecting surface, the top of the plastic bag is a decorative surface, and a transparent or semi-transparent structure is arranged at the position corresponding to the LED luminous tube on the decorative surface. By means of arranging the luminous component in the sealed plastic bag, the utility patent not only has the functions of luminescence and vocalization, but also has waterproof function and is suitable for the products which are easy to get wet and need to be washed.

2. The said decorative laminated patch with LED, according to claim 1, is characterized in that the connection surface of the said plastic bag is fixedly connected to either the hook or the loop of a Velcro.

3. The said decorative laminated patch with LED, according to claim 1, is characterized in that: the outside of the sealed periphery of the plastic bag has a connection edge extending to the surrounding.

4. The said decorative laminated patch with LED, according to claim 1, is characterized in that: the connection surface of the said plastic is fixedly connected with a snap button.

5. The said decorative laminated patch with LED, according to claim 1, is characterized in that: it is equipped with 3 LED luminotrons, but not limited to 3 LED luminotrons, which are respectively of the red, green and yellow colors.

6. The said decorative laminated patch with LED, according to claim 1, is characterized in that: the referred printed circuit board has a sound circuit.

7. The said decorative laminated patch with LED, according to claim 1, is characterized in that: the referred control circuit is equipped with a delay-off circuit.
